(19) United States
(12) Patent Application Publication
(10) Pub. No.: US 2026/0192420 A1
(43) Pub. Date: Jul. 9, 2026

(54) INDEXING SQUARE BREAKER BAR

(71) Applicant: Snap-on Incorporated, Kenosha, WI (US)

(72) Inventors: Scott A. Bendorf, Kenosha, WI (US); George R.R. Call, Milwaukee, WI (US); Mark E. Lewis, Coxsackie, NY (US)

(73) Assignee: Snap-on Incorporated, Kenosha, WI (US)

(21) Appl. No.: 19/013,515

(22) Filed: Jan. 8, 2025

(51) Int. Cl. B25B 23/00; B25B 13/48

(52) U.S. Cl. CPC B25B 23/0028; B25B 13/481

(57) ABSTRACT

The present invention includes a tool comprising a drive square with a splined portion, which may index and lock into a corresponding splined bore mounted on a drive handle. This arrangement allows the user to index and lock the square-to-handle orientation with an extended array of positions. The user is able to alternate the direction of torque applied without operation of a direction lockout lever, risk of unwanted rotation, and with a greater range of square orientations than conventional tools.

### BACKGROUND OF THE INVENTION

The present invention relates to hand tools having an indexing joint mechanism.

Work pieces, such as bolts or nuts, intended to be serviced may be located within close proximity of obstructions in a variety of automotive and industrial equipment. Hydraulic lines, for example, may be densely populated in close proximity to each other on a hydraulic manifold and make servicing individual components difficult as existing tools will interfere with other components as the hydraulic nuts are rotated for installation or removal. Likewise, when working on an engine in an engine bay of a vehicle, there are often many obstacles that must be contended with while servicing a work piece.

Fixed and ratcheting square lugged tools make servicing work pieces with obstacles difficult. The fixed lug design, such as with a breaker bar, allows for limited positioning of the fastener engagement tool (e.g., socket, crow-foot, torque adapter, etc.) and may not allow for adequate tool and handle positioning relative to the components located around the work piece being serviced. While a fixed lugged tool offers the ability to change the rotational direction of torque applied through the lug, it has a small limit of handle to socket orientations.

Likewise, ratcheting lugged tools (such as ratchet wrenches) can cause the socket or crow-foot to inadvertently change rotational position. While a ratcheting lugged tool allows for a greater amount of handle to square orientations, it requires frequent ratchet gear pawl lever changes and may also allow for undesired rotation of the tool while operating.

Other solutions implement use of a splined engagement into a male square (capable of engaging in standard square drive tools) to allow for square orientation to be indexable relative to the drive handle. However, addition of an adaptor to accommodate traditional square drive tools does not lend to a compact tool nature. In a confined use case environment, such tool does not prove suitable as it can interfere with surrounding components about the fastener of interest.

### SUMMARY OF THE INVENTION

In an embodiment, the present invention broadly comprises a tool having a shaft with opposing first and second ends, the first end includes a handle and the second end includes a head. A splined bore is disposed in the head, wherein the splined bore includes an inner splined surface. A joint pin having first and second ends and including a smooth surface portion is disposed adjacent to the first end, a lug portion disposed adjacent to the second end and that is adapted to releasably engage lugged aperture tools, and a splined portion disposed between the smooth surface portion and the lug portion. The joint pin is axially movable in the splined bore between locked and unlocked positions, wherein when the pin is disposed in the unlocked position, the smooth surface portion is disposed adjacent to the inner splined surface and the joint pin is adapted to rotate relative to the splined bore, and when the joint pin is disposed in the locked position, the splined portion meshingly engages the inner splined surface so that the joint pin is rotatably fixed relative to the splined bore.

### BRIEF DESCRIPTION OF DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an exemplary tool incorporating an embodiment of the present invention in a disassembled state.

FIG. 2 is a perspective view of an embodiment of an exemplary tool incorporating an embodiment of the present invention.

FIG. 3 is a side view of the tool of FIG. 2.

FIG. 4A is a side view of an embodiment of a joint pin of the present invention.

FIG. 4B is another embodiment of a joint pin of the present invention.

FIG. 5 is a cross-sectional view of another embodiment of a joint pin of the present invention.

FIG. 6A is a perspective view of the joint pin of FIG. 5.

FIG. 6B is a perspective views of the joint pin of FIG. 5 in a disassembled state.

FIG. 7A is an enlarged partial perspective view of an exemplar tool incorporating an embodiment of the present.

FIG. 7B is an enlarged partial perspective view of an exemplar tool incorporating an embodiment of the present.

FIGS. 8A-8E are top views of an exemplar tool incorporating an embodiment of the present invention showing different indexed positions.

FIGS. 9A-9B are side views of an embodiment of an joint pin, according to the present invention.

FIGS. 10A-10B are respective cross-sectional views of the joint pin of FIGS. 9A-9B.

FIGS. 11A-11D are side views of other embodiments of joint pins of the present invention.

FIGS. 12A-12B are additional side views of an embodiment of joint pin according to the present invention.

FIG. 13 is a perspective view of the joint pin of FIGS. 12A-12B.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates to hand tools having an indexing joint mechanism. In an embodiment, the tool of the present invention includes a handle, a shaft, and an indexing joint mechanism that includes a conventional outwardly protruding square lug that is adapted to releasably couple with conventional tool extensions that are adapted to engage a work piece (e.g., sockets, extensions, or crow-foot).

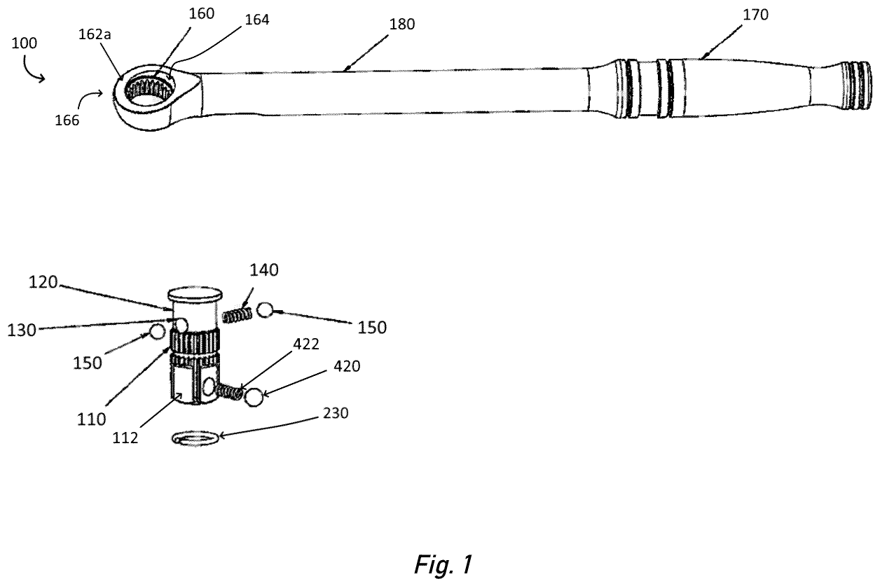

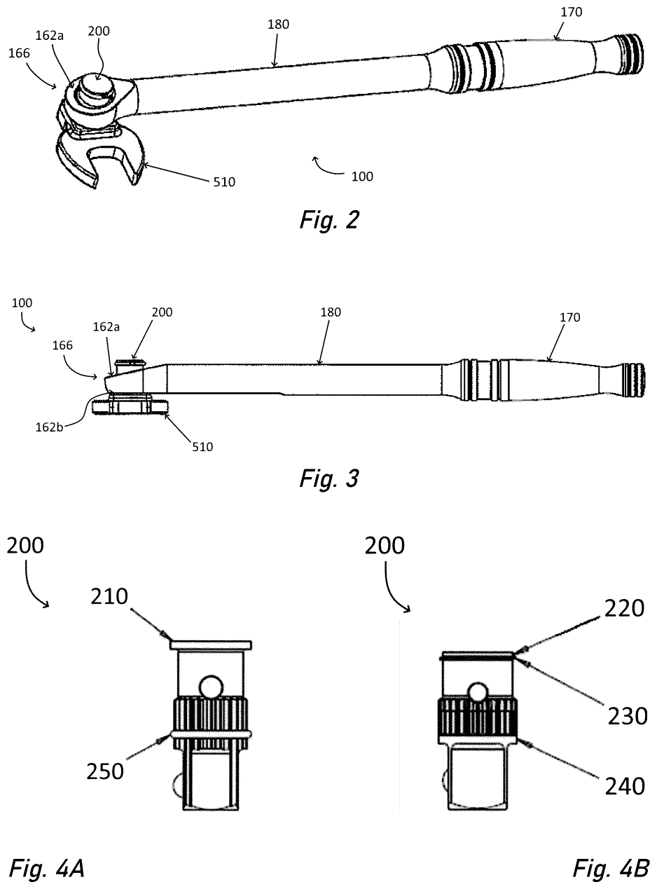

Referring to FIG. 1 through FIGS. 4A-4B, in an embodiment, the tool 100 includes a shaft 180 with opposing first and second ends. A handle portion 170 is disposed on the first end, and a head 166 with a splined bore 160 having an inner splined surface is disposed on the second end.

The tool 100 further includes a joint pin 200 having opposing first and second ends. The joint pin 200 includes a smooth surface portion 120 disposed adjacent to the first end, a lugged portion 112 disposed adjacent to the second end, and a splined portion 110 disposed between the smooth surface and lugged portions 120, 112. The lugged portion 112 may be a square lug that is adapted to be releasably engage square lugged aperture tools 510, such as, for example, sockets, extensions, or crow-foot. However, it will be appreciated that while the present invention is described as having a conventional square lug, any other type of lug shape can be used without departing from the spirit and scope of the present invention.

In an embodiment, the lugged portion 112 may include a bore with a biasing spring 422 and detent ball 420 that is biased outwardly by the biasing spring 422. Such detent ball 420 is adapted to engage a corresponding detent disposed on a releasably coupled tool 510 in a well-known manner.

The joint pin 200 is adapted to axially move within the splined bore 160. In an embodiment, the joint pin 200 is axially movable relative to the splined bore 160 between locked and unlocked positions. When the joint pin 200 is disposed in the locked position, the splined portion 110 meshingly engages the splines on the inner splined surface of the splined bore 160, thereby fixedly locking rotational movement between the splined bore 160 and joint pin 200. It will be understood that when disposed in the locked position, torque can be applied to an engaged work piece by applying torque to the handle 170. When the joint pin 200 is disposed in the unlocked position, the smooth surface portion 120 is disposed adjacent to the inner splined surface of the splined bore 160, and the splined portion 110 is disengaged from the inner splined surface of the splined bore 160. The smooth surface portion 120 has an outer diameter that is less than the inner diameter of the splined bore 160, so that, when disposed in the unlocked position, the joint pin 200 can rotate relative to the splined bore 160.

Accordingly, a user can selectively choose the angular position between the lugged portion 112 and the splined bore 160 by axially moving the joint pin 200 to the unlocked position, so that the smooth surface portion 120 is disposed adjacent to the inner splined surface of the splined bore 160, rotating the joint pin 200 relative to the splined bore 160 to a desired angle, and when the desired angle is achieved, axially moving the joint pin 200 to the locked position so that the splined portion 110 of the joint pin meshingly engages the inner splined surface of the splined bore 160, thereby locking the angle between the joint pin 200 and splined bore 160, and subsequently the handle 170.

In an embodiment, the joint pin 200 may include an outwardly extending flange portion 210. Likewise, the head 166 with the splined bore 160 may include a shoulder portion 162a. The outer diameter of the outwardly extending flange 210 is greater than the inner diameter of the shoulder portion 162a. Accordingly, when the joint pin 200 is axially moved to the unlocked position, the outwardly extending flange portion 210 of the joint pin 200 abuts the shoulder portion 162a, thereby preventing the joint pin 200 from inadvertently being axially pushed through the splined bore 160 all of the way.

In an embodiment, the joint pin 200 may include a circumferential groove 250 disposed adjacent to or in the splined portion 110. The circumferential groove 250 is adapted to receive a retaining ring 230 that has an outer diameter that is greater than the inner diameter of the splined bore 160. The retaining ring 230 is adapted to prevent the joint pin 200 from being pushed axially through the splined bore 160 when the joint pin 200 is moved to the locked position. Thus, the retaining ring 230 and flange 210 together prevent the joint pin 200 from being pushed through the splined bore 160 all the way in either axial direction.

In an embodiment, the joint pin 200 may include a traverse bore 130 disposed on the smooth portion 120 adjacent to the splined portion 110. The bore 130 is adapted to house a spring 140 and opposing detent balls 150. The balls 150 are sized to be fit into the bore, but can still be biased outwardly by the spring 140. It will be understood that the spring 140 and balls 150 can detain the joint pin 200 in either of the locked or unlocked positions. In another embodiment, the bore 130 may house one spring and one detent ball 150. It will also be understood that the spring 140 may be any suitable biasing means, such as, for example, a helical spring, disc spring, leaf spring, elastomeric spring, and the like.

For example, in an embodiment, when the joint pin 200 is disposed in the locked position, the spring 140 biases the balls 150 outwardly, thereby causing the balls 150 to abut the first shoulder 162a of the head 166. To axially move the joint pin 200 to the unlocked position from the locked position, a user can axially push the joint pin 200 to overcome the spring 140 bias, thus pushing the balls 150 inwardly, allowing the joint pin 200 to move axially. Then, when the joint pin 200 is disposed in the unlocked position, the balls 150 are again biased outwardly and abut a second shoulder 162b of the head 166. The shoulders 162a, 162b may have a tapered portion 164 adjacent to the splined bore 160, such that when a user axially pushes the joint pin 200, the taper 164 directs force radially inward, pushing the balls 150 inwardly to overcome the bias. Accordingly, the spring 140 and balls 150 can selectively detain the joint pin 200 in either of the locked and unlocked positions.

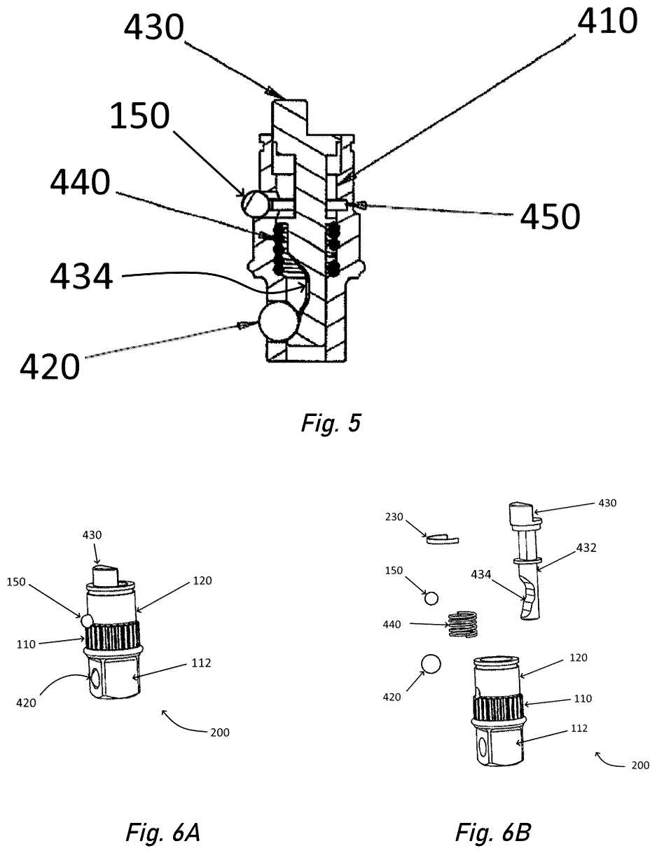

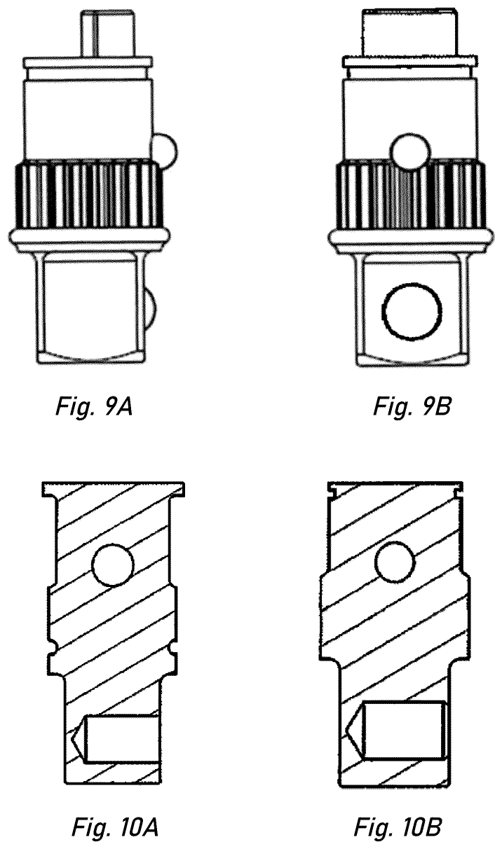

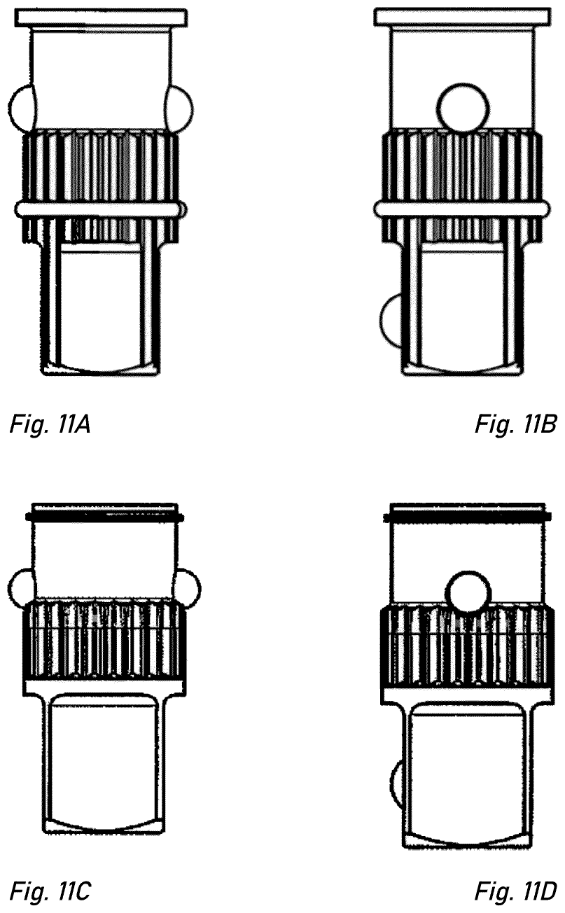

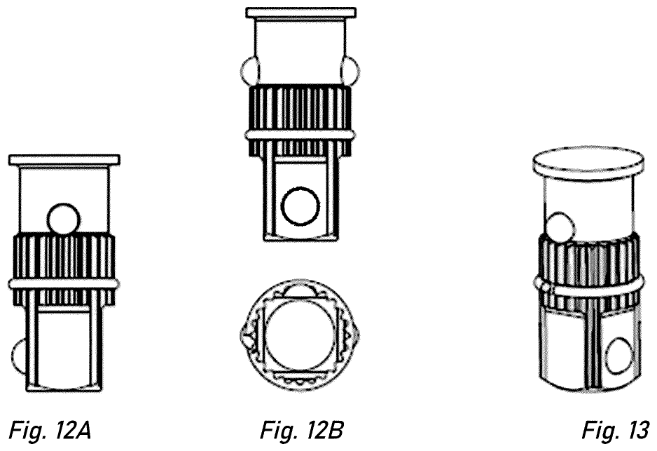

In another embodiment as exemplified in FIGS. 5, 6A-6B, 9A-9B, 10A-10B, the joint pin 200 may include a locking mechanism that is adapted to selectively lock a tool 510 to the square lug. In such embodiment, the joint pin 200 may include a bore 410 extending axially therethrough, with a pin-insert 430 inserted into the axial bore 410. The joint pin 200 includes a smooth portion 120, a lugged portion 112, and a splined portion 110 therebetween. The joint pin 200 includes a detent ball 150, which is sized to be disposed into a transverse bore in the joint pin 200, but can be biased outwardly by a biasing means, such as, for example, a retainer ring 450. The pin-insert 430 may include a button or tab, raised above the opening of the axial bore 410 and raised relative to a first distal end of the joint pin 200. The pin-insert 430 is biased by a spring 440 inside the axial bore 410, the spring 440 biasing the pin-insert 430 towards the first distal end by spring 440. The pin-insert 430 may include a shaft having a distal portion 432 having a key 434 (e.g., a cut-away concave shaped portion). The lugged portion 112 of the joint pin 200 includes a transverse bore, which may pass partly or all the way transversely through the lugged portion 112, in which a detent ball 420 is inserted, such that the pin-insert 430 outwardly biases the detent ball 420. Such detent ball is thereby, in its biased configuration, slightly raised from the surface of the lugged portion 112 of the joint pin 200, and is adapted to engage a corresponding detent disposed on a releasably coupled tool 510 in a well-known manner. This embodiment of the joint pin 200 is adapted such that when a user presses the pin-insert 130, the spring 440 is compressed and the pin-insert 130 is movable axially relative to the joint pin 200, and the key 434 of the pin-insert 430 becomes aligned with the detent ball 420, thereby permitting the detent ball 420 to move radially inwardly relative to the joint pin 200, and permitting release of the releasably coupled tool 510. Conversely, when the pin-insert 130 is disposed in a locked state, the key 434 is not aligned with the detent ball 420, but rather the shaft of the pin-insert 130 is aligned with the detent ball 420, thereby preventing the detent ball 420 from moving inwardly, and thus locking a tool to the lug.

When the joint pin 200 is disposed in the locked position in the splined bore 160, the biasing means, e.g., retainer ring 450, biases the ball 150, thereby causing the ball 150 to abut a first shoulder 162a of the head 166. To axially move the joint pin 200 to the unlocked position, a user can axially push the joint pin 200 to overcome the bias force of the biasing means 450, thus pushing the ball 150 inwardly, allowing the joint pin 200 to the ball 150 outwardly, so that the ball 150 abuts a second shoulder 162b of the head 166. The head 166 may include a tapered portion 164 adjacent to the splined bore 160, such that when a user axially pushes the joint pin, the taper 164 directs force radially inward, pushing the balls 150 inwardly. Accordingly, the biasing means 450 and ball 150 can selectively detain the joint pin 200 in either of the locked position and unlocked position.

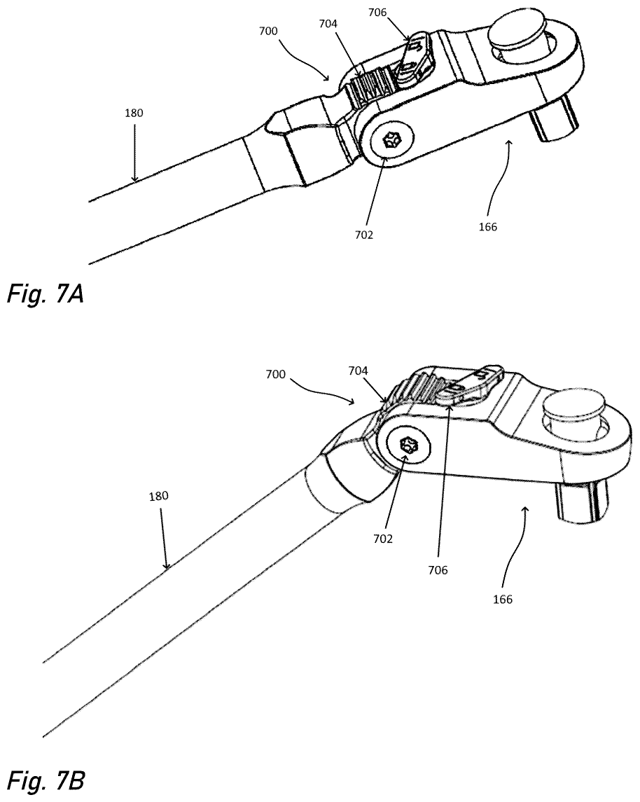

With reference to FIGS. 7A-7B, an exemplar tool incorporating an embodiment of the present invention is shown. As illustrated, the joint pin 200 may be inserted in a splined bore 160 which is positioned on the head 166 which is affixed to a shaft 180 having a handle portion 170. The head 166 may be positioned on an indexable neck 700, which is affixed to a distal end of the shaft 180. The indexable neck 700 may include an indexing hinge 702 and gear 704, which permits the head 166 to be angularly adjustable. The flexible neck 700 may include a locking mechanism 706. When the locking mechanism 706 is toggled to an unlocked position, a user may change the angle of the head 166 relative to the shaft 180. The user may, when the head 166 is at the desired angle, toggle the locking mechanism 706 into a locked position, thereby angularly fixing the head 166 relative to the shaft 180 at a chosen angle.

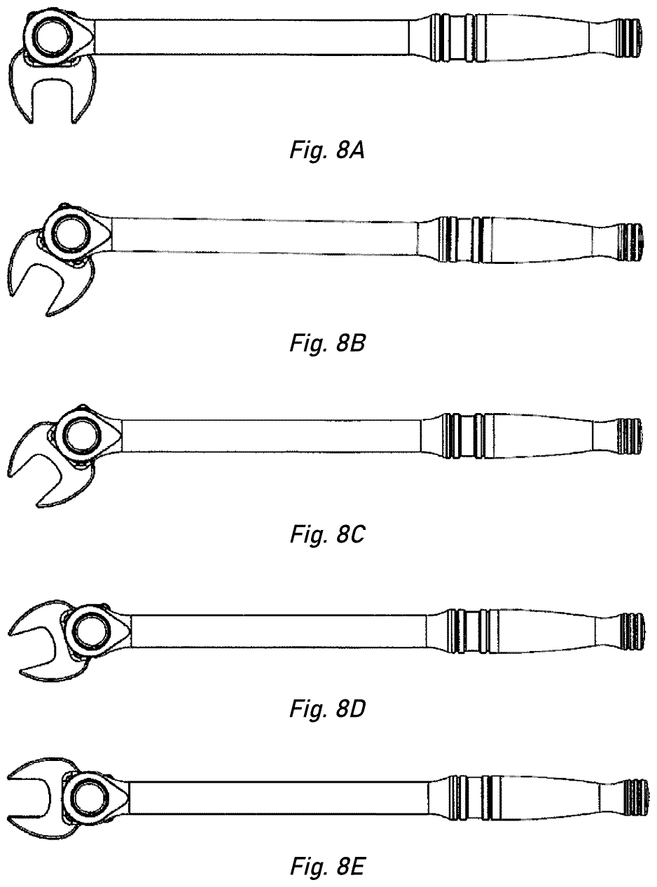

Through the operation of the tool 100 of the present invention, a user may fix the joint pin 200 at a radial angle relative to the shaft 180. With a releasable tool 510 attached to the lugged portion 112 of the pin 200, a user may thus set the releasable tool 510 at any suitable angle the user wants. Various exemplary angular configurations are shown with an exemplary tool incorporating the present invention in FIGS. 8A-8E.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors'contribution. The actual scope of the protection sought is intended to be defined in the following claims when viewed in their proper perspective based on the prior art.

1. A tool having a shaft with opposing first and second ends, the first end includes a handle and the second end includes a head, the tool comprising:
a splined bore disposed in the head, the splined bore includes an inner splined surface; and
a joint pin having opposing first and second ends, a smooth surface portion disposed adjacent to the first end, a lug portion disposed adjacent to the second end and that is adapted to releasably engage lugged aperture tools, and a splined portion disposed between the smooth surface portion and the lug portion,
wherein the joint pin is axially movable in the splined bore between locked and unlocked positions, wherein when the pin is disposed in the unlocked position, the smooth surface portion is disposed adjacent to the inner splined surface and the joint pin is adapted to rotate relative to the splined bore, and when the joint pin is disposed in the locked position, the splined portion meshingly engages the inner splined surface so that the joint pin is rotatably fixed relative to the splined bore.

2. The tool as claimed in claim 1, wherein the splined bore includes a splined bore diameter and an inner shoulder, the joint pin further includes a outwardly extending flange disposed at the first end, the flange has a flange diameter that is greater than the splined bore diameter, wherein when the pin is disposed in the unlocked position, the flange abuts the inner shoulder to prevent the joint pin from being axially removed from the splined bore.

3. The tool as claimed in claim 1, wherein the lug portion includes a lug portion bore and a lug spring and ball disposed in the lug portion bore, wherein the spring is adapted to bias the ball outwardly to detainably engage a lugged tool.

4. The tool as claimed in claim 1, wherein the smooth surface portion includes a smooth surface portion bore and a spring and ball disposed in the smooth surface portion bore, the spring is adapted to bias the ball outwardly to selectively detain the joint pin in either of the locked or unlocked positions.

5. The tool of claim 1, wherein the lug portion further includes a traverse bore with a detent ball disposed therein, wherein the ball is adapted to be biased outwardly to engage a detent of an attachable tool.

6. The tool of claim 5, wherein the joint further includes an axial bore with a depressible button disposed at a distal end, wherein the button includes a key and is biased to a locked state and depressible to an unlocked state, wherein when the button is disposed in the locked state, the key is not aligned with the detent ball, thereby preventing the detent ball from moving inwardly, and when the button is depressed to the unlocked state, the key is aligned with the detent ball, and the detent ball can move inwardly.

7. The tool of claim 6, wherein depressing the button to the unlocked state permits the lugged aperture tool that is engaged with the lug to be removed.

8. The tool of claim 1, wherein the lugged aperture tool is a socket, crow-foot, or torque adapter.

9. An indexing breaker bar tool including a handle with opposing first and second ends and a head disposed at the second end, the breaker bar tool comprising:
a splined bore disposed in the head, the splined bore includes an inner splined surface, wherein the inner splined surface comprises gear teeth or ridges; and
a pin having first and second ends and that is adapted to be axially movable in the splined bore, wherein the pin includes a smooth surface portion disposed adjacent to the first end, a lug portion disposed adjacent to the second end and that is adapted to releasably engage a lugged aperture tool, and a splined portion disposed between the smooth surface portion and the lug portion;
wherein the pin is axially movable in the splined bore between locked and unlocked positions, wherein when the pin is disposed in the unlocked position, the smooth surface portion is disposed adjacent to the inner splined surface and the pin is adapted to rotate relative to the splined bore, and when the pin is disposed in the locked position, the splined portion of the pin meshingly engages the inner splined surface so that the pin is rotatably fixed relative to the splined bore; and
wherein the smooth surface portion of the pin includes at least one smooth surface portion bore with a biasing spring and a ball disposed therein, the spring is adapted to bias the ball radially outwardly to selectively detain the joint pin in either of the locked and unlocked positions.
